(19) United States
(12) Patent Application Publication
(10) Pub. No.: US 2006/0050693 A1
(43) Pub. Date: Mar. 9, 2006

(54) Building data packets for an advanced switching fabric

(76) Inventors: James Bury, Chandler, AZ (US); Andrew Tan, Chandler, AZ (US); Joseph A. Bennett, Roseville, CA (US)

Correspondence Address: FISH & RICHARDSON, PC, P.O. BOX 1022, MINNEAPOLIS, MN, 55440-1022, US

(21) Appl. No.: 10/934,074

(22) Filed: Sep. 3, 2004

(51) Int. Cl. H04L 12/56

(52) U.S. Cl. 370/389; 370/396; 370/398

(57) ABSTRACT

An apparatus generates a data packet for an advanced switching (AS) fabric. The apparatus includes a direct memory access (DMA) engine that retrieves a descriptor from a queue, and that stores the descriptor in a storage area. The descriptor contains information used to build the data packet. A work manager retrieves the descriptor from the storage area, and works to generate the data packet using the descriptor.

### TECHNICAL FIELD

This patent application relates to building data packets for an Advanced Switching (AS) fabric.

### BACKGROUND

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with, or as a possible replacement for, PCI in computer systems. [The PCI Express architecture is described in the PCI Express Base Architecture Specification, Revision 1.0 (Initial release Jul. 22, 2002), which is available through the PCI-SIG (PCI-Special Interest Group) (http://www.pcisig.com)].

AS is an extension to the PCI Express architecture. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The AS architecture is described in the Advanced Switching Core Architecture Specification, Revision 1.0 (December 2003), which is available through the ASI-SIG (Advanced Switching Interconnect-SIG) (http//:www.asi-sig.org).

### DESCRIPTION OF THE DRAWINGS

FIG. 1 is a block diagram of a switched fabric network.

FIG. 2 shows protocol stacks for PCI Express and AS architectures.

FIG. 3 illustrates an AS transaction layer packet (TLP) format.

FIG. 4 illustrates an AS route header format.

FIG. 5 is a block diagram of an architecture of an AS fabric end node device.

FIG. 6 is a flowchart of a process that may be executed on the AS fabric end node device.

FIGS. 7, 8 and 9 are diagrams showing data structures of descriptors used with the AS fabric end node device.

FIG. 10 is a block diagram of a data storage system that uses an AS fabric end node device and the process of FIG. 6.

FIG. 11 is a block diagram of a network that uses an AS fabric end node device and the process of FIG. 6.

FIG. 12 is a flowchart of a process that may be executed on the AS fabric end node device.

Like reference numerals in different figures indicate like elements.

### DESCRIPTION

Generally speaking, a switching fabric is a combination of hardware and software that moves data coming into a network node out the correct port to a next network node. A switching fabric includes switching elements, e.g., individual devices in a network node, integrated circuits contained therein, and software that controls switching paths through the switch fabric.

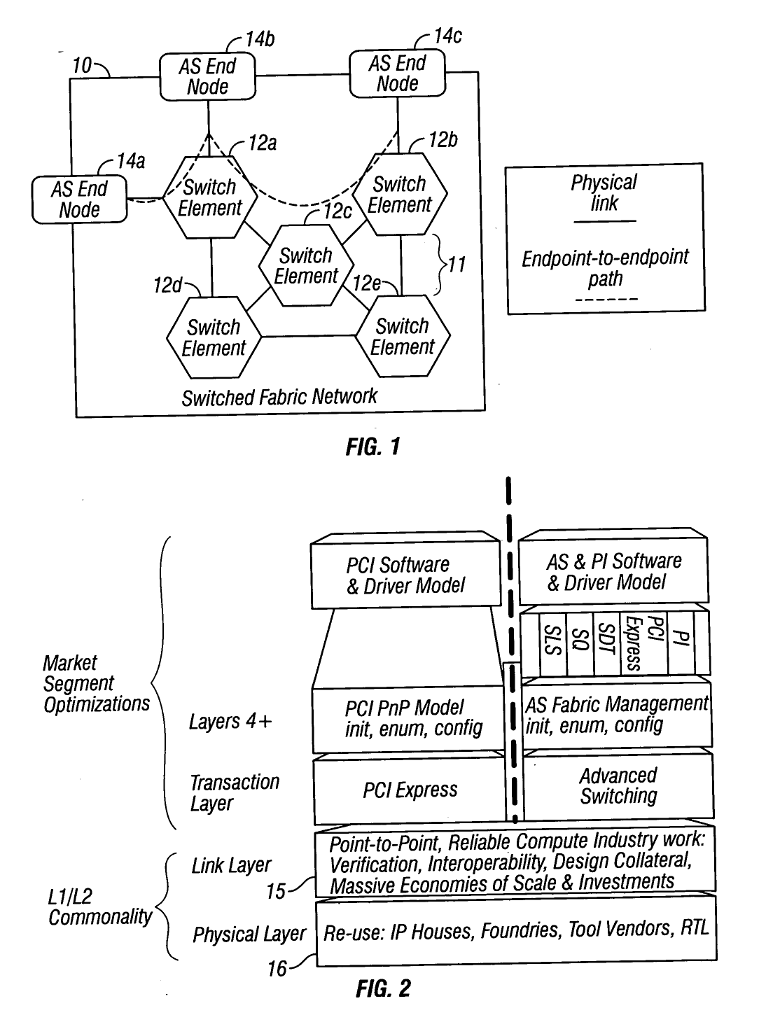

FIG. 1 shows a network 10 constructed around an AS fabric 11. AS fabric 11 is a specialized switching fabric that is constructed on the data link and physical layers of PCI express technology. AS fabric 11 uses routing information in packet headers to move data packets through the AS fabric between end nodes of the AS fabric. Any type of data packet may be encapsulated with an AS packet header and transported through the AS fabric. As fabric 11 also supports native protocols, such as simple load store (SLS), described below.

In FIG. 1, switch elements 12a to 12e constitute internal nodes of the network and provide interconnects with other switch elements and end nodes 14a to 14c. End nodes 14a to 14c reside on the “edges” of the AS fabric 11 and handle input and/or output of data to/from AS fabric 11. End nodes 14a to 14c may encapsulate and/or translate packets entering and exiting the AS fabric 11 and may be viewed as “bridges” between AS fabric 11 and interfaces to other networks, devices, etc. (not shown).

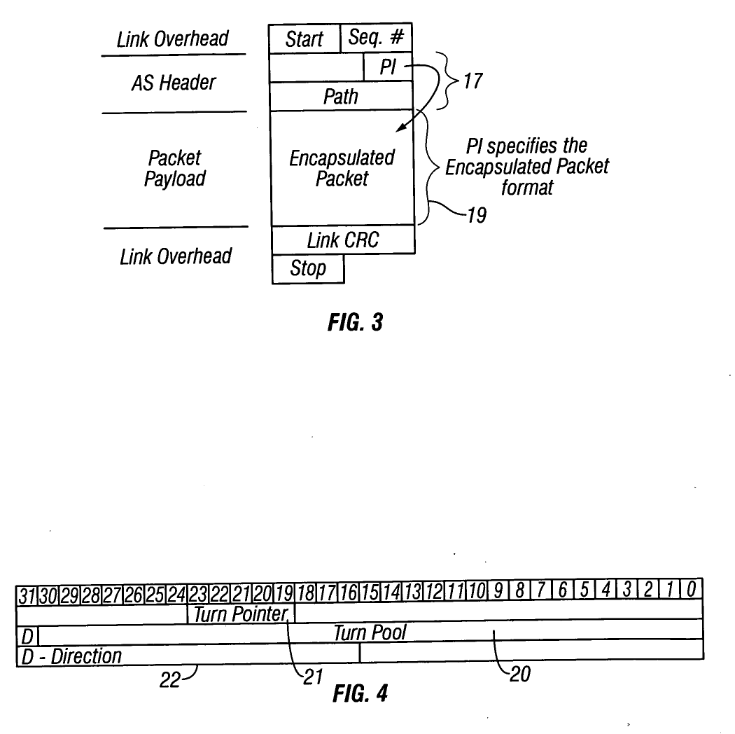

As shown in FIG. 2, AS fabrice 11 utilizes a packet-based transaction layer protocol that operates over the PCI Express physical and data link layers 15, 16. AS uses a path-defined routing methodology in which the source of a packet provides all information required by a switch (or switches) to route the packet to a desired destination.

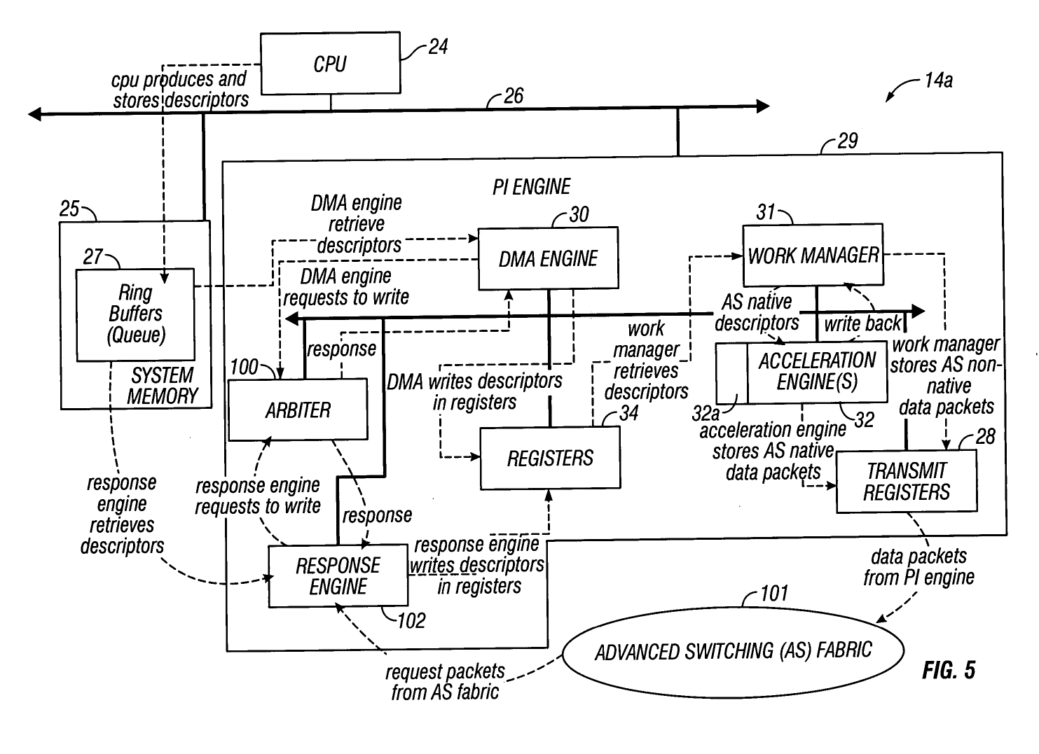

FIG. 3 shows an AS transaction layer packet (TLP) format. The packet includes a route header 17 and an encapsulated packet payload 19. The AS route header 17 contains information that is used to route the packet through AS fabrice 11 (i.e., “the path”), and a field that specifies the Protocol Interface (PI) of the encapsulated packet. AS switches use the information contained in the route header 11 to route packets and do not care about the contents of the encapsulated packet.

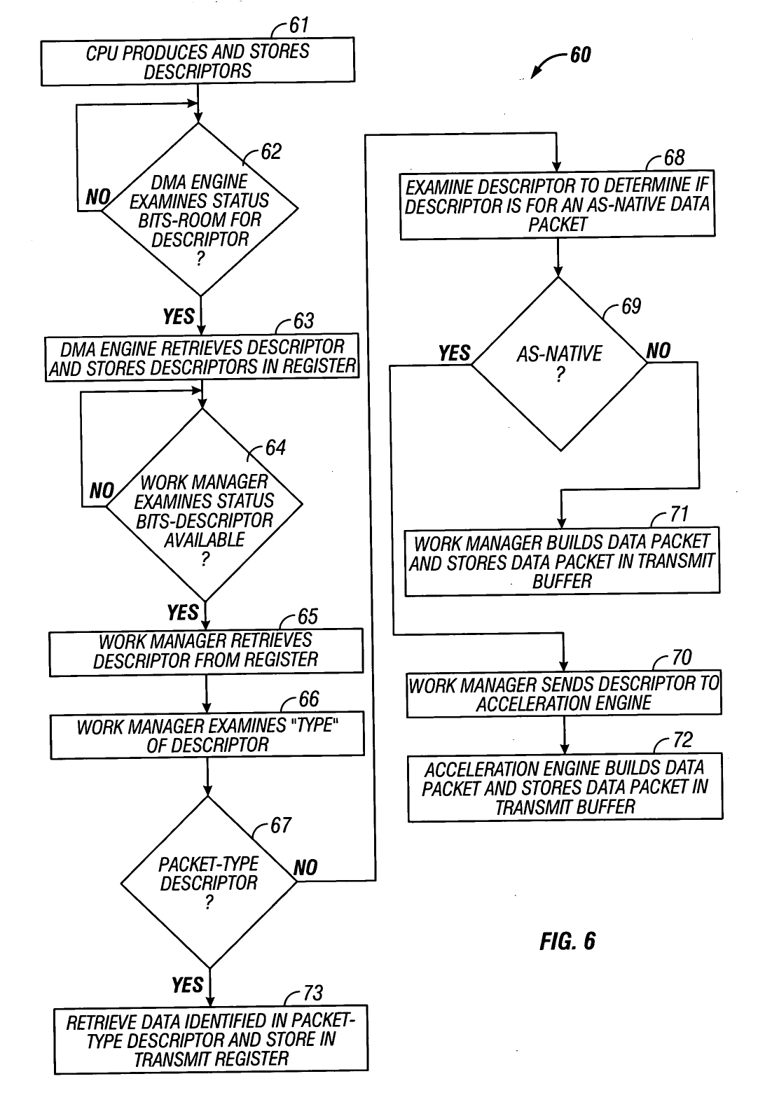

Referring to FIG. 4, a path may be defined by a turn pool 20, a turn pointer 21, and a direction flag 22 in the route header. A packet's turn pointer indicates the position of a switch's “turn value” within the turn pool. When a packet is received, the switch may extract the packet's turn value using the turn pointer, the direction flag, and the switch's turn value bit width. The extracted turn value for the switch may then used to calculate the egress port.

The PI field in the AS route header specifies the format of the encapsulated packet. The PI field is inserted by the end node that originates the AS packet and is used by the end node that terminates the packet to correctly interpret the packet contents. The separation of routing information from the remainder of the packet enables an AS fabric to tunnel packets of any protocol.

PIs represent fabric management and application-level interfaces to AS fabric 11. Table 1 provides a list of PIs currently supported by the AS Specification.

TABLE 1
AS protocol encapsulation interfaces

| PI number | Protocol Encapsulation Identity (PEI) |
|---|---|
| 0 | Fabric Discovery |
| 1 | Multicasting |
| 2 | Congestion Management |
| 3 | Segmentation and Reassembly |
| 4 | Node Configuration Management |
| 5 | Fabric Event Notification |
| 6 | Reserved |
| 7 | Reserved |
| 8 | PCI-Express |
| 9-223 | ASI-SIG defined PEIs |
| 224-254 | Vendor-defined PEIs |
| 255 | Invalid |

PIs 0-7 are reserved for various fabric management tasks, and PIs 8-254 are application-level interfaces. As shown in Table 1, PI8 is used to tunnel or encapsulate native PCI Express. Other PIs may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the establishment of direct end node-to-end node logical paths known as Virtual Channels (VCs). This enables a single AS fabric network to service multiple, independent logical interconnects simultaneously. Each VC interconnecting AS end nodes for control, management and data. Each VC provides its own queue so that blocking in one VC does not cause blocking in another. Since each VC has independent packet ordering requirements, each VC can be scheduled without dependencies on the other VCs.

The AS architecture defines three VC types: Bypass Capable Unicast (BVC); Ordered-Only Unicast (OVC); and Multicast (MVC). BVCs have bypass capability, which may be necessary for deadlock free tunneling of some, typically load/store, protocols. OVCs are single queue unicast VCs, which are suitable for message oriented “push” traffic. MVCs are single queue VCs for multicast “push” traffic.

The AS architecture provides a number of congestion management techniques, one of which is a credit-based flow control technique that ensures that packets are not lost due to congestion. Link partners in the network (e.g., an end node 14a and a switch element 12a) exchange flow control credit information to guarantee that the receiving end of a link has the capacity to accept packets. Flow control credits are computed on a VC-basis by the receiving end of the link and communicated to the transmitting end of the link. Typically, packets are transmitted only when there are enough credits available for a particular VC to carry the packet. Upon sending a packet, the transmitting end of the link debits its available credit account by an amount of flow control credits that reflects the packet size. As the receiving end of the link processes (e.g., forwards to an end node 14a) the received packet, space is made available on the corresponding VC and flow control credits are returned to the transmission end of the link. The transmission end of the link then adds the flow control credits to its credit account.

The AS architecture supports an AS Configuration Space in each AS device in the network. The AS Configuration Space is a storage area that includes fields that specify device characteristics, as well as fields used to control the AS device. The information is presented in the form of capability structures and other storage structures, such as tables and a set of registers. The information stored in the AS-native capability structures can be accessed through PI-4 packets, which are used for device management. In one embodiment of an AS fabric network, AS end node devices are restricted to read-only access of another AS device's AS native capability structures, with the exception of one or more AS end nodes that have been elected as fabric managers.

A fabric manager election process may be initiated by a variety of hardware or software mechanisms. A fabric manager is an AS end node that “owns” all of the AS devices, including itself, in the network. If multiple fabric managers, e.g., a primary fabric manager and a secondary fabric manager, are elected, then each fabric manager may own a subset of the AS devices in the network. Alternatively, the secondary fabric manager may declare ownership of the AS devices in the network upon a failure of the primary fabric manager, e.g., resulting from a fabric redundancy and fail-over mechanism.

Once a fabric manager declares ownership, it has privileged access to its AS devices' AS native capability structures. In other words, the fabric manager has read and write access to the AS native capability structures of all of the AS devices in the network, while the other AS devices are restricted to read-only access, unless granted write permission by the fabric manager.

AS fabrice 11 supports the simple load store (SLS) protocol. SLS is a protocol that allows one end node device, such as the fabric manager, to store, and access, data in another end node device's memory, including, but not limited to, the device's configuration space. Memory accesses that are executed via SLS may be direct, meaning that an accessing device need not go through a local controller or processor on an accessed device in order to get to the memory of the accessed device. SLS data packets are recognized by specific packet headers that are familiar to AS end node devices, and are passed directly to hardware on the end node devices, which performs the requested memory access(s).

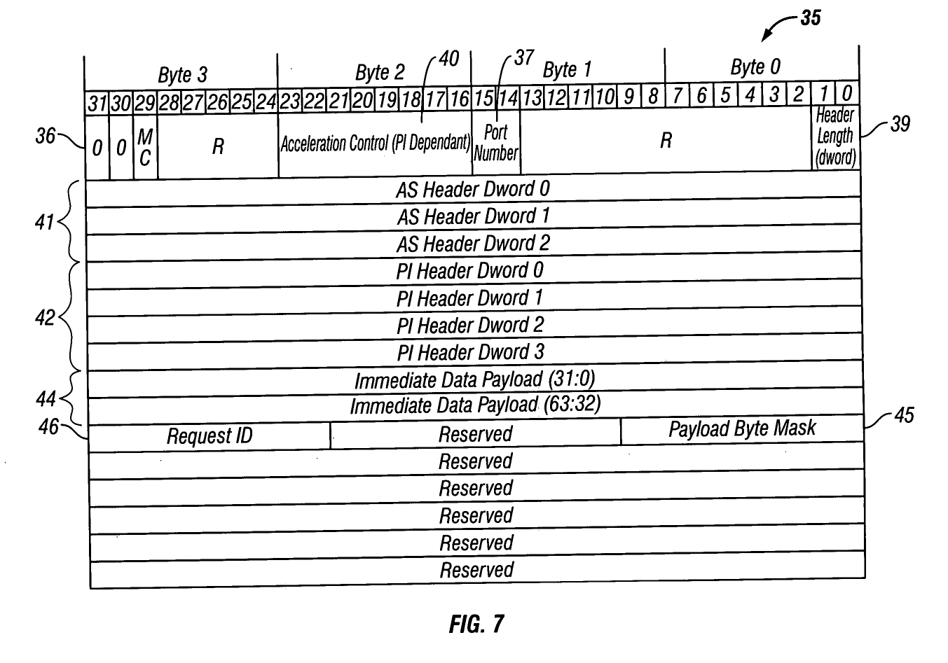

FIG. 5 shows an architecture of an AS fabric end node device 14a. The arrows in FIG. 5 represent possible data flows between the various elements shown. It is noted that FIG. 5 only shows components of the AS fabric end node device that are relevant to the current description. Other components may be present.

End node device 14a uses direct memory access (DMA) technology to build data packets for transmission to AS fabric 11. DMA is a technique for transferring data from memory without passing the data through a central controller (e.g., a processor) on the device. Device 14a may be a work station, a personal computer, a server, a portable computing device, or any other type of intelligent device capable of executing instructions and connecting to AS fabric 11.

Device 14a includes a central processing unit (CPU) 24. CPU 24 may be a microprocessor, microcontroller, programmable logic, or the like, which is capable of executing instructions (e.g., a computer program) to perform one or more operations. Such instructions may be stored in system memory 25, which may be one or more hard drives or other internal or external memory devices connected to CPU 24 via one or more communications media, such as a bus 26. System memory 25 may include designated ring buffers 27, which together make up a queue, for use in transmitting data packets to, and receiving data packets from, AS fabric 11.

Device 14a also includes protocol interface (PI) engine 29. PI engine 29 may include one or more separate hardware devices, or may be implemented in software running on CPU 24. In this embodiment, PI engine 29 is implemented on a separate chip which communicates with CPU 24 via bus 26, and which may communicate with one or more PCI express devices (not shown) via PCI express bus(es) (also not shown).

PI engine 29 functions as CPU 24's interface to AS fabric 11. In this embodiment, PI engine 29 contains a DMA engine 30, a work manager engine 31, one or more acceleration engines 32, and an arbiter 100. Registers 34 are included in PI engine 29 for use by its various components, and may include one or more first-in first-out (FIFO) registers. Transmit registers 28 provide a “transmit” interface to advanced switching (AS) fabric 11. PI engine 29 also contains a response engine 102 which receives data packets from a “receive” interface (not shown) to AS fabric 11.

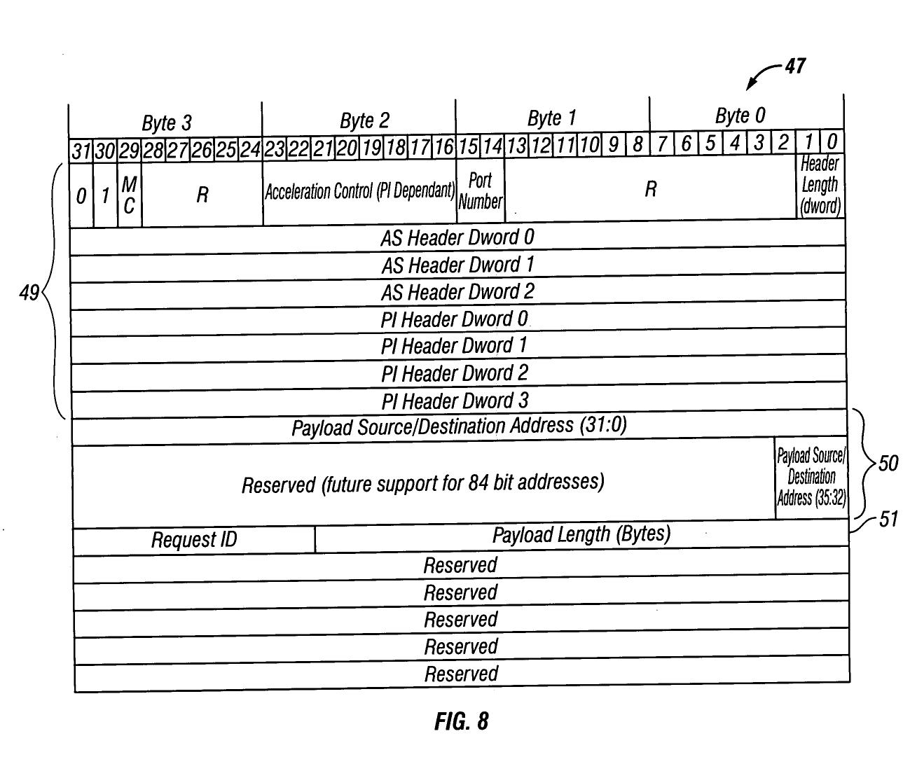

DMA engine 30 is a direct memory access engine, which retrieves descriptors from ring buffers 27, and which stores the descriptors in registers 34. As described below, descriptors are data structures that contain information used to build data packets. Work manager 31 is an engine that controls work flow among entities used to build data packets, including DMA engine 30 and acceleration engines 32. Work manager 31 also builds data packets for non-native AS protocols. Acceleration engines 32 are protocol-specific engines, which build data packets for predefined native AS protocols. The operation of these components of PI engine 29 is described below with respect to FIG. 6.

Different descriptor formats are supported by device 14a. Examples of such descriptor formats include the “immediate” descriptor format, the “indirect” descriptor format, and the “packet-type” descriptor format. An immediate descriptor contains all data needed to build a data packet for transmission over the AS fabric, including the payload of the packet. An indirect descriptor contains all data needed to build a data packet, except for the packet's payload. The indirect descriptor format instead contains one or more addresses identifying the location, in ring buffers 27, of data for the payload. A packet-type descriptor identifies a section of memory that is to be extracted and transmitted as a data packet. The packet-type descriptor is not used to format a packet, but instead is simply used to extract data specified at defined memory addresses, and to transmit that data as a packet. In this embodiment, each descriptor is 32 bits (one “D-word”) wide and sixteen D-words long.

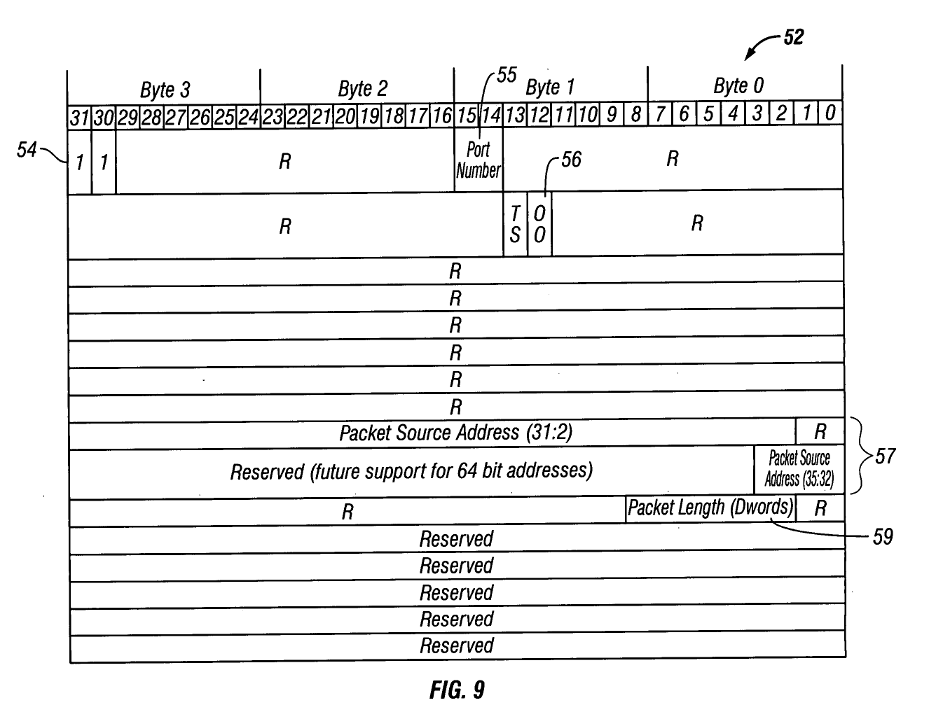

An example of an immediate descriptor 35 is shown in FIG. 7. In FIG. 7, bits 36 contain control information that identifies the “type” of the descriptor, e.g., immediate, indirect, or packet. Bits 37 contain a port number of device 14a for transmission of a resulting data packet. Bits 39 identify the length of the packet header. Byte 40 contains acceleration control information. As described in more detail below, the acceleration control information is used to determine how a data packet is built from the descriptor, i.e., which engines are used to build the data packet. D-words 41 contain information used to build a unicast or multicast route header, including a unicast address and/or multicast group address. D-words 42 contain non-routing packet header information, e.g., information to distinguish and combine data packets. D-words 44 contain data that makes up the payload of the data packet. Bits 45 identify bytes to be ignored in a payload. Bits 46 contains an identifier (ID) that identifies a packet request. The portions labeled “R” or “Reserved” are reserved for future use.

An example of an indirect descriptor 47 is shown in FIG. 8. Section 49 of the indirect descriptor is identical to that of immediate descriptor 35 (FIG. 7). In place of data for the payload, indirect descriptor 47 contains data 50 identifying starting address(es) for the payload. Indirect descriptor also contains data 51 identifying the length of the payload.

An example of a packet-type descriptor 52 is shown in FIG. 9. Packet-type descriptor 52 contains bits 54 identifying the data packet as a packet-type descriptor; bits 55 identifying a port number associated with the data packet; and bits 56 used in the AS route header. Packet-type descriptor 52 also contains data 57 identifying the starting address(es), in system memory, of data that makes up the packet. The length 59 of the data, in D-words, is also provided in packet-type descriptor 52.

FIG. 6 shows a process 60 by which end node device 14a generates data packets for transmission to AS fabric 11. In process 60, CPU 24 produces (61) descriptors and stores them in a queue in system memory 25. In this embodiment, the queue is comprised of eight ring buffers 27—one ring buffer per virtual channel supported by end node device 14a.

DMA engine 30 retrieves descriptors from ring buffers 27 for storage in registers 34. In this embodiment, there are eight registers capable of holding two descriptors each, and DMA engine 30 retrieves the descriptors in the order in which they were stored in the buffers, i.e., first-in, first-out.

Each of registers 34 includes one or more associated status bits. These status bits indicate whether a register contains zero, one or two descriptors. The status bits are set, either by DMA engine 30 or work manager 31 (described below). DMA engine 30 determines whether to store the descriptors based on the status bits of registers 34. More specifically, as described below, work manager 31 processes (i.e., “consumes”) descriptors from registers 34. Once a descriptor has been consumed from a register, work manager 31 resets the status bits associated with that register to indicate that the register is no longer full. DMA engine 30 examines (62) the status bits periodically to determine whether a register has room for a descriptor. If so, DMA engine 30 retrieves (63) a descriptor (or two) from the ring buffers and consults arbiter 100 as to whether DMA engine 30 can store the descriptor(s) in registers 30. As described below, arbiter 100 is a part of PI engine 29 that arbitrates access to registers 34 by DMA engine 30 and response engine 102 (also described below). If storage is approved by arbiter 100, DMA engine 30 stores that descriptor in an appropriate register. DMA engine 30 stores the descriptor in a register that is dedicated to the same virtual channel as the ring buffer from which the descriptor was retrieved. DMA engine 30 may also store a tag associated with each descriptor in registers 34. Use of this tag is described below.

Work manager 31 examines (64) the status bits of each register to determine whether a descriptor is available for processing. If a descriptor is available, work manager 31 retrieves (65) that descriptor and process the descriptor in the manner described below.

A priority level associated with each register may affect how the work manager retrieves descriptors from the registers. More specifically, each register may be assigned a priority level. The priority level indicates, to work manager 31, a number of descriptors to retrieve from a target register before retrieving descriptors from other registers. Circuitry (not shown), such as a counter, associated with each register maintains the priority level of each register. The circuitry stores a value that corresponds to the priority level of an associated register, e.g., a higher value indicates a higher priority level. Each time work manager 31 retrieves a descriptor from the target register, the circuitry increments a count, and the current value of the count is compared to the priority level value. So long as the count is less than or equal to the priority level value of a target register, work manager 31 continues to retrieve descriptors only from the target register. If no descriptors are available from the target register, work manager 31 may move on to another register, and retrieve descriptors from that other register until descriptors from the target register become available.

Work manager 31 examines (66) retrieved descriptors in order to determine a type of the descriptor. In particular, work manager 31 examines the ID bytes of each descriptor to determine the type of the descriptor. Since packet-type descriptors simply define “chunks” of data as a packet, packet-type descriptors do not contain acceleration control information (see FIG. 9). Hence, when a packet-type descriptor is identified (67), work manager 31 simply retrieves (73) data specified in the descriptor by address and packet length, and uses that data as the packet. No formatting or other processing is performed on the data. The resulting “packet” is stored in transmit registers 28 for transmission onto AS fabric 11.

For immediate descriptors and indirect descriptors, work manager 31 also examines the descriptor to determine whether the descriptor is for a data packet having a protocol that is native to AS, such as SLS, or for packets that have a protocol that is non-native to AS, such as ATM. In particular, work manager 31 examines the acceleration control information of immediate descriptors and indirect descriptors.

If the acceleration control information indicates (69) that the descriptor is for a data packet having a protocol that is non-native to AS fabric 11, work manager 31 builds (71) one or more data packets from the descriptor.

If the descriptor is an immediate descriptor, work manager 31 builds a data packet using the descriptor. In particular, work manager 31 builds a packet header from D-words 41 and 42 (FIG. 7) which, as noted above, contain route information and non-route information, respectively. Work manager 31 builds the payload using D-words 44 which, as noted above, contain the payload for the data packet.

If the descriptor is an indirect descriptor, work manager 31 builds a header for the data packet in the same manner as for an immediate descriptor. Work manager 31 builds a packet payload by retrieving a payload for the packet from address(es) 50 (FIG. 8) specified in the descriptor. Work manager 31 retrieves data from the first address specified. In this embodiment, AS packets are limited to 320 bytes. If the amount of the payload specified in the descriptor causes the packet length to exceed 320 bytes, work manager 31 builds a packet that is 320 bytes. Work manager then builds another packet, using substantially the same header information as the first data packet, and a different payload. The payload, in this case, includes data from the address(es) specified in the descriptor, starting at the address where the first data packet ended. The header information in this next data packet includes the same routing information as the first data packet, but a different packet identifier (ID) to differentiate it from the first data packet. Work manager 31 continues to build data packets in this manner until all of the data specified in the indirect descriptor has been packetized (i.e., “consumed”).

Work manager 31 stores data packets in transmit registers 28, from which the data packets are output to AS fabric 11.

Referring back to FIG. 6, work manager 31 may determine (69) that the acceleration control information in a data packet indicates that the packet-type descriptor is for a data packet that has a protocol that is native to AS fabric 11, e.g., SLS. In this case, work manager 31 parses the descriptor and sends (70) the resulting information to the appropriate acceleration engine, e.g., acceleration engine 32a for SLS packets. Work manager 31 instructs acceleration engine 32a to build data packet(s) from the descriptor information, thereby freeing work manager 31 for other tasks, such as building packets for “non-native” descriptors. In response to the instruction from work manager 31, acceleration engine 32a builds a data packet.

Work manager 31 uses a tag system to keep track of packet processing with acceleration engines 32. As noted above, work manager 31 retrieves all necessary information/data it needs from registers 34, along with an associated tag. For native AS packets, work manager 31 instructs an acceleration engine 32 to build the packet (e.g., if the packet is SLS).

After building the packet header, acceleration engine 32 sends a payload fetch request to work manager 31 to request payload for the packet. Along with the request, the acceleration engine sends a copy of the tag that work manager 31 forwarded to acceleration engine 32. The returned tag, however, has been altered to instruct work manager 31 to retrieve payload for the packet, and to provide the payload to the acceleration engine for packet building.

When building the data packet, acceleration engine 32a issues a write back command to work manager 31. If the payload of the data packet is too big to be accommodated in a single packet, the write back command identifies the data that has been packetized by acceleration engine 32a. Specifically, the write back command specifies the ending address of the packetized data. Work manager 31 receives the write back command and determines whether all of the data in the original descriptor has been packetized (e.g., work manager 31 determines if the ending address in the write back command corresponds to the ending address of the total amount of data to be packetized). If all of the data has been packetized, work manager 31 sets the status bits of a corresponding register 34 to indicate that there is room for another descriptor. If all of the data in the original descriptor has not been packetized, work manager 31 instructs acceleration engine 32a to build another data packet using substantially the same packet header information as the previous data packet. Work manager 31 instructs acceleration engine 32a that the payload for this next packet is to start at the address at which the previous packet ended. The back-and-forth process between the acceleration engine and the work manager continues until the entire descriptor has been consumed.

Acceleration engine 32a stores completed data packets in transmit registers 28 for transmission onto AS fabric 11.

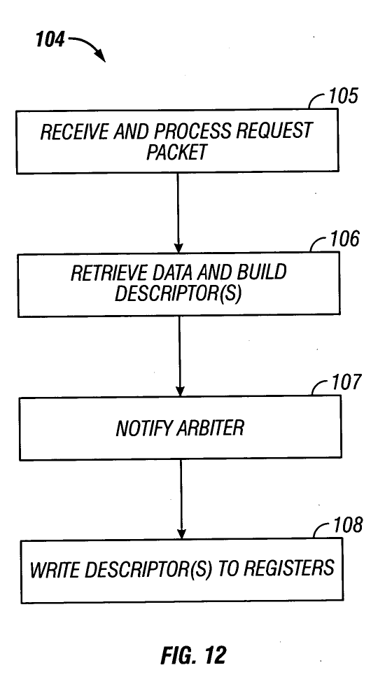

FIG. 12 shows a process 104 for responding to requests from AS fabrice 11 using PI engine 29. As shown in FIGS. 5 and 12, response engine 102 receives (105) a request packet from AS fabrice 11 (receipt may be via a packet receiving engine (not shown)). The request packet may be issued by another AS end node device (not shown), and may be an SLS request packet or any other type of native AS packet that requests data from device 14a.

Response engine 102 processes the received request packet. For example, response engine 102 parses the data packet to identify its type (e.g., SLS), data that is being requested via the receive packet, the destination to which that data should be sent, and any other relevant information contained in the request packet. When processing the request packet, response engine 102 determines which data to provide in a response based, e.g., on address information contained in the request packet. Address translations or conversions may be performed by response engine 102 in order to correlate address(es) in the request packet to system memory address(es) from which data is to be read.

Response engine 102 retrieves (106) data from appropriate addresses in system memory and builds one or more descriptors using that data. The descriptors are essentially the same as the descriptors described above, except that they are built by response engine 102 instead of by CPU 24. Response engine 102 may support any of the descriptor formats described herein. Different formats may be associated, e.g., with different AS end node devices or different types of request packets.

Response engine 102 notifies (107) arbiter 100 that response engine 102 has descriptors to write/store in registers 34. Arbiter 100 gives priority to response engine 102, meaning that arbiter 100 allows response engine 102 to write its descriptors to registers 34 first, ahead of DMA engine 30. This is because, generally speaking, PI engine 29 gives priority to external requests over data transmissions. Response engine 102 writes (108) its descriptors to registers 34. Response engine 102 may also store a tag associated with each descriptor in registers 34, as described. Thereafter processing proceeds as set forth in FIG. 6 from block “65” on.

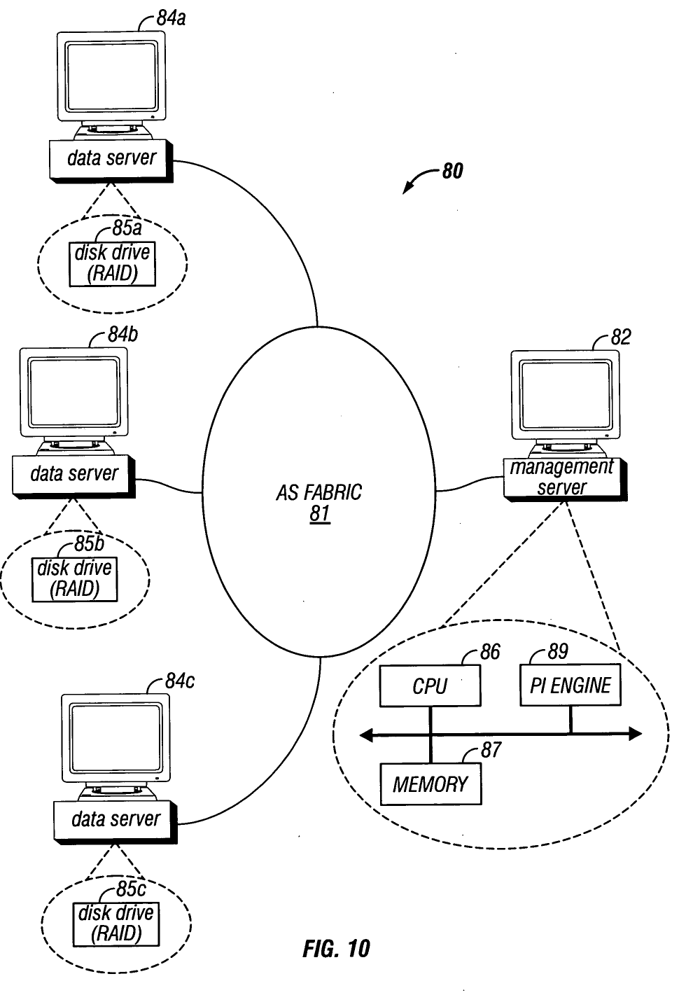

The AS end node device described herein may be used in any context. For example, an AS end node device may be used in a storage system 80, as shown in FIG. 10, which passes data among various data servers across AS fabric 81. Storage system 80 includes a management server 82 that acts as a manager for storage system 80. Management server 82 controls storage and access of data to/from other data servers in the system. These other data servers 84a, 84b, 84c are each in communication with management server 82 via AS fabric 81. Data servers 84a, 84b, 84c may each contain one or more disk drives 85a, 85b, 85c (e.g., redundant array of inexpensive disks (RAID)) to store data received via AS fabric 81.

As shown in FIG. 10, management server 82 includes a CPU 86 that stores descriptors in a queue (e.g., ring buffers) in memory 87. As described above, the descriptors contain information used to packetize data for transmission across AS fabric 81. Management server 82 also contains a protocol interface (PI) engine 89 that retrieves descriptors from memory 87, and that uses the descriptors to generate data packets for transmission to one or more of the other data servers via AS fabric 81. PI engine 89 has substantially the same configuration and function as PI engine 29 of FIG. 5.

PI engine 89 includes a DMA engine to retrieve descriptors from memory 87 and to store those descriptors in a register. PI engine 89 also includes a work manager that retrieves a descriptor, and that determines, based on the descriptor, whether the data packet has a format that is native to AS fabric 81. If the data packet has a format that is non-native, then the work manager builds one or more data packets from the descriptor, as described above. If the data packet has a format that is native, the work manager sends the descriptor to an acceleration engine, along with a command. The acceleration engine receives the descriptor from the work manager, and uses the information in the descriptor to build the data packet. As described above, the work manager and the acceleration engine may operate together to build multiple data packets from the same descriptor.

The data packets generated by PI engine 89 may be SLS data packets, which enable management server 82 to access and to store data in memories of the other data servers 84a, 84b, 84c without “going through” their CPUs.

One or more of the other data serves 84a, 84b, 84c may act as a local management server for a sub-set of data servers (or other data servers). Each server in this sub-set may include RAID or other storage media, which the local management server can access without going through a local CPU. The architecture of such a data server 84a is similar to that of management server 82. For example, the local management server may include a local processor that stores local descriptors in a local queue. The local descriptors contain information used to packetize local data for transmission across AS fabric 81 or another AS fabric. The data packets may have an SLS format or other format. A local PI engine retrieves local descriptors from local memory, and uses the local descriptors to generate data packets for transmission to one or more other data servers' memory.

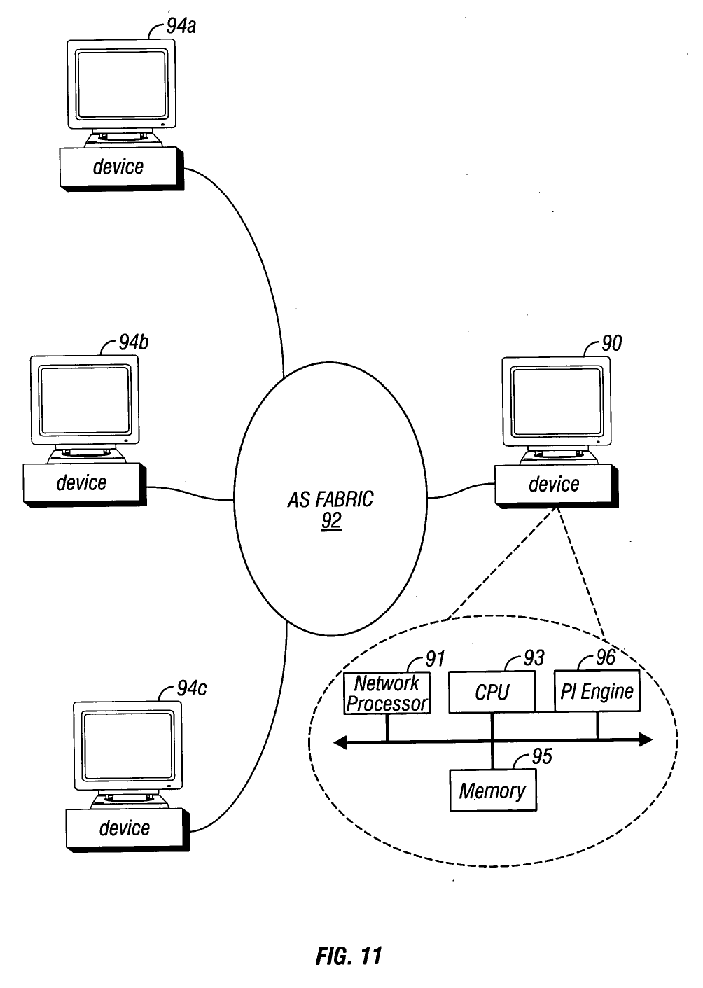

The AS end node device described herein may also be used in connection with a network processor. For example, as shown in FIG. 11, end node device 90 may contain a network processor 91 that identifies a condition, such as congestion, on a network containing AS fabric 92. End node device 90 contains a CPU 93 that receives an indication of the condition from network processor 91, and that generates descriptors, such as those described herein, in response to the condition. The descriptors contain information used to build data packets, e.g., to request that one or more of network devices 94a, 94b, 94c connected to AS fabric 92 halt or reduce operation in order to alleviate the congestion. As above, CPU 93 stores the descriptors in a memory 95. A PI engine 96 retrieves the descriptors from memory, and uses the descriptors to generate data packets for transmission to other network devices 94a, 94b, 94c via AS fabric 92. As above, PI engine 96 includes a DMA engine that retrieves descriptors from memory, and that stores the descriptor in registers. A work manager retrieves the descriptors from the registers, and works, either alone or with one or more acceleration engines, to generate data packets using the descriptors. As described above, the work manager and an SLS acceleration engine may work together to generate multiple SLS packets from a single descriptor.

The foregoing are only two examples of systems in which an AS end node device of FIG. 5 may be implemented. The AS end node device may be employed in other systems not specifically described herein.

Furthermore, processes 60 and 104 are not limited to use with the hardware and software described herein; they may find applicability in any computing or processing environment Processes 60 and 104 can be implemented in digital electronic circuitry, or in computer hardware, firmware, software, or in combinations of them. The processes can be implemented as a computer program product or other article of manufacture, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Processes 60 and 104 can be performed by one or more programmable processors executing a computer program to perform functions. Process 60 and 104 can also be performed by, and apparatus of the process 60 and 104 can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

Information carriers suitable for embodying computer program instructions and data include all forms of non-volatile memory, including by way of example semiconductor memory devices, e.g., EPROM (electrically programmable read-only memory), EEPROM (electrically erasable programmable read-only memory), and flash memory devices; magnetic disks, e.g., internal hard disks or removable disks; magneto-optical disks; and CD-ROM (compact disc read-only memory) and DVD-ROM (digital video disc read-only memory). The processor and the memory can be supplemented by, or incorporated in special purpose logic circuitry.

Processes 60 and 104 can be implemented in a computing system that includes a back-end component, e.g., as a data server, or that includes a middleware component, e.g., an application server, or that includes a front-end component, e.g., a client computer, or any combination of such back-end, middleware, or front-end components.

The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other.

Other embodiments not described herein are also within the scope of the following claims.

What is claimed is:

1. An apparatus that generates a data packet for an advanced switching (AS) fabric, the apparatus comprising:
a direct memory access (DMA) engine that retrieves a descriptor from a queue, and that stores the descriptor in a storage area, the descriptor containing information used to generate the data packet; and
a work manager that retrieves the descriptor from the storage area, and that works to generate the data packet using the descriptor.

2. The apparatus of claim 1, wherein the storage area comprises registers, the registers having different priority levels; and
wherein the work manager retrieves the descriptor from a target register in accordance with a priority level of the target register.

3. The apparatus of claim 2, wherein the target register has an associated counter, the counter containing a value corresponding to a priority level of the target register, the value indicating to the work manager a number of descriptors to retrieve from the target register before retrieving descriptors from other registers.

4. The apparatus of claim 1, wherein the descriptor contains data comprising one of a payload of the data packet, a pointer to data comprising a payload of the data packet, and a pointer to data to be transmitted as the data packet.

5. A method of producing a data packet for an advanced switching (AS) fabric, the method comprising:
retrieving a descriptor from a queue, the descriptor comprising information used to build the data packet; and
determining if the descriptor indicates that the data packet has a format that is native to the AS fabric;
wherein, if the descriptor indicates that the data packet has a format that is native to the AS fabric, the method further comprises performing a first process to build the data packet, and if the descriptor indicates that the data packet has a format that is not native to the AS fabric, the method further comprises performing a second process to build the data packet.

6. The method of claim 5, wherein:
retrieving is performed by a first engine and determining is performed by a second engine; and
the first process comprises the second engine instructing a third engine to build the data packet.

7. The method of claim 5, wherein:
retrieving is performed by a first engine and determining is performed by a second engine; and
the second process comprises the second engine building the data packet.

8. The method of claim 5, wherein the descriptor is retrieved from the queue and stored in a storage area.

9. The apparatus of claim 8, wherein the storage area has an associated counter, the counter containing a value corresponding to a priority level of the storage area, the value indicating a number of descriptors to retrieve from the storage area before retrieving descriptors from other storage areas.

10. An article comprising a machine-readable medium that stores instructions to build a data packet for an advanced switching (AS) fabric, the instructions causing a machine to:
retrieve a descriptor from a queue, the descriptor comprising information used to build the data packet; and
determine if the descriptor indicates that the data packet has a format that is native to the AS fabric;
wherein, if the descriptor indicates that the data packet has a format that is native to the AS fabric, the instructions cause the machine to perform a first process to build the data packet, and if the descriptor indicates that the data packet has a format that is not native to the AS fabric, the instructions cause the machine to perform a second process to build the data packet.

11. The article of claim 10, wherein:
retrieving is performed by a first software engine and determining is performed by a second software engine; and
the first process comprises the second software engine instructing a third software engine to build the data packet.

12. The article of claim 10, wherein:
retrieving is performed by a first software engine and determining is performed by a second software engine; and
the second process comprises the second software engine building the data packet.

13. The article of claim 12, wherein the descriptor is retrieved from the queue and stored in a storage area.

14. The article of claim 12, wherein the storage area has an associated counter, the counter containing a value corresponding to a priority level of the storage area, the value indicating a number of descriptors to retrieve from the storage area before retrieving descriptors from other storage areas.

15. A storage system that passes data across an advanced switching (AS) fabric, the storage system comprising:
a first server to manage the storage system; and
plural data servers, each of the plural data servers being in communication with the first server via the AS fabric, the plural data servers each containing one or more disk drives to store data received from the first server via the AS fabric;
wherein the first server comprises:
a processor that stores a descriptor in a queue, the descriptor containing information used to packetize data for transmission across the AS fabric; and
a protocol interface (PI) engine that retrieves the descriptor from the queue, and that uses the descriptor to generate data packets for transmission to one or more of the plural data servers via the AS fabric.

16. The data storage system of claim 15, wherein:
at least one of the plural data servers comprises a redundant array of inexpensive disks (RAID); and
the data packets comprise simple load store (SLS) data packets for storing data in the RAID.

17. The data storage system of claim 15, wherein the PI engine comprises:
a direct memory access (DMA) engine that retrieves the descriptor from the queue, and that stores the descriptor in a storage area; and
a work manager that retrieves the descriptor from the storage area, and that works to generate the data packets using the descriptor.

18. A network containing an advanced switching (AS) fabric and an end node device, the end node device comprising:
a network processor that identifies a condition on the network;
a processor that generates a descriptor in response to the condition, and that stores the descriptor in a queue, the descriptor containing information used to build a data packet; and
a protocol interface (PI) engine that retrieves the descriptor from the queue, and that uses the descriptor to build the data packet for transmission to another network device via the AS fabric.

19. The network of claim 18, wherein the PI engine comprises:
a direct memory access (DMA) engine that retrieves the descriptor from the queue, and that stores the descriptor in a storage area; and
a work manager that retrieves the descriptor from the storage area, and that works to build the data packet using the descriptor.

20. The network of claim 18, wherein the condition comprises congestion on the network and the data packet comprises a request to alleviate the congestion.

21. An apparatus to generate data packets for transmission to an advanced switching (AS) fabric, the apparatus comprising:
a work manager that retrieves a descriptor containing information used to build a data packet, and that determines, based on the descriptor, whether the data packet has a format that is native to the AS fabric; and
an acceleration engine that receives the descriptor from the work manager if the data packet has a format that is native to the AS fabric, and that uses the information in the descriptor to build the data packet;
wherein the work manager and the acceleration engine operate to build multiple data packets from the descriptor.

22. The apparatus of claim 21, wherein:
the descriptor contains a pointer to data comprising a payload of the data packet, the data having a size that exceeds a permissible size of the data packet; and
the acceleration engine builds a first data packet using a first part of the data, and thereafter issues a write back command to the work manager.

23. The apparatus of claim 22, wherein the write back command contains an address in the data that corresponds to the payload for a next data packet.

24. The apparatus of claim 23, wherein, in response to the write back command, the work manager instructs the acceleration engine to build a next data packet using the descriptor, and the acceleration engine builds the next data packet using a second part of the data as payload.

25. The apparatus of claim 21, further comprising:
a direct memory access (DMA) engine that reads the descriptor from a queue, and that stores the descriptor in a storage area, the work manager retrieving the descriptor from the storage area.

26. The apparatus of claim 25, wherein the work manager informs the DMA engine when the descriptor has been consumed and, in response, the DMA engine stores a new descriptor in the storage area.

27. An apparatus for use with an advanced switching (AS) fabric, the apparatus comprising:
a first engine to provide a descriptor containing information for at least one data packet, the information identifying a payload of the at least one data packet;
a second engine to determine, based on the descriptor, whether the least one data packet has a native AS format; and
a third engine to build the at least one data packet using the descriptor if the second engine determines that the at least one data packet has a native AS format;
wherein the second engine and the third engine work together to build plural data packets from the descriptor if the information in the descriptor indicates that the payload is too large to be accommodated by a single data packet.

28. The apparatus of claim 27, wherein the native format comprises simple load store (SLS).

29. The apparatus of claim 27, wherein the second and third engines build the plural data packets as follows:
the third engine sends a command to the second engine after producing an N^{th} (N≧1) data packet;
the second engine receives the command and determines, based on the command, whether the payload has been completely packetized; and
if the payload has not been completely packetized, the second engine instructs the third engine to build an (N+1)^{th} data packet using a portion of the payload that has not already been packetized.

30. The apparatus of claim 29, wherein, if the payload has been completely packetized, the second engine informs the first engine, and the first engine responds by providing a new descriptor.

31. A method for use with an advanced switching (AS) fabric, the method comprising:
providing a descriptor containing information for at least one data packet, the information identifying a payload of the at least one data packet;
determining, based on the descriptor, whether the least one data packet has a native AS format; and
building the at least one data packet using the descriptor if it is determined that the at least one data packet has a native AS format;
wherein plural data packets are built from the descriptor if the information in the descriptor indicates that the payload is too large to be accommodated by a single data packet.

32. The method of claim 31, wherein a first engine provides the descriptor and second and third engines build the plural data packets as follows:
the third engine sends a command to the second engine after producing an N^{th} (N≧1) data packet;
the second engine receives the command and determines, based on the command, whether the payload has been completely packetized; and
if the payload has not been completely packetized, the second engine instructs the third engine to build an (N+1)^{th} data packet using a portion of the payload that has not already been packetized.

33. The method of claim 31, wherein, if the payload has been completely packetized, the second engine informs the first engine, and the first engine responds by providing a new descriptor.

34. An article comprising a machine-readable medium that stores instructions for use with an advanced switching (AS) fabric, the instructions causing a machine to:
provide a descriptor containing information for at least one data packet, the information identifying a payload of the at least one data packet;
determine, based on the descriptor, whether the least one data packet has a native AS format; and
build the at least one data packet using the descriptor if it is determined that the at least one data packet has a native AS format;
wherein plural data packets are built from the descriptor if the information in the descriptor indicates that payload is too large to be accommodated by a single data packet.

35. The article of claim 34, wherein the instructions define first, second and third software engines, the first software engine provides the descriptor and the second and third software engines build the plural data packets as follows:
the third software engine sends a command to the second software engine after producing an N^{th} (N≧1) data packet;
the second software engine receives the command and determines, based on the command, whether the payload has been completely packetized; and
if the payload has not been completely packetized, the second software engine instructs the third software engine to build an (N+1)^{th} data packet using a portion of the payload that has not already been packetized.

36. The article of claim 35, wherein, if the payload has been completely packetized, the second software engine informs the first software engine, and the first software engine responds by providing a new descriptor.

37. A storage system that passes data across an advanced switching (AS) fabric, the storage system comprising:
a first server to manage the storage system; and
plural data servers, each of the plural data servers being in communication with the first server via the AS fabric, the plural data servers each containing one or more disk drives to store data received from the first server via the AS fabric;
wherein the first server comprises:
a work manager that reads a descriptor containing information used to build a data packet, and that determines, based on the descriptor, whether the data packet has a format that is native to the AS fabric; and
an acceleration engine that receives the descriptor from the work manager if the data packet has a format that is native to the AS fabric, and that uses the information in the descriptor to build the data packet;
wherein the work manager and the acceleration engine operate to build multiple data packets from the descriptor.

38. The data storage system of claim 37, wherein:
at least one of the plural data servers comprises a redundant array of inexpensive disks (RAID); and
the data packets comprise simple load store (SLS) data packets for storing data in the RAID.

39. The data storage system of claim 37, wherein the first server further comprises:
a direct memory access (DMA) engine that reads the descriptor from a queue, and that stores the descriptor in a storage area, the work manager reading the descriptor from the storage area.

40. A network containing an advanced switching (AS) fabric and an end node device, the end node device comprising:
a network processor that identifies a condition on the network;
a processor that generates a descriptor in response to the condition, and that stores the descriptor in a queue, the descriptor containing information used to build a data packet; and
a protocol interface engine comprising:
a work manager that obtains the descriptor, and that determines, based on the descriptor, whether the data packet has a format that is native to the AS fabric; and
an acceleration engine that receives the descriptor from the work manager if the data packet has a format that is native to the AS fabric, and that uses the information in the descriptor to build the data packet;
wherein the work manager and the acceleration engine operate to build multiple data packets from the descriptor.

41. The network of claim 40, wherein the PI engine further comprises:
a direct memory access (DMA) engine that retrieves the descriptor from the queue, and that stores the descriptor in a storage area from which the work manager obtains the descriptor.

42. The network of claim 41, wherein the condition comprises congestion on the network and the data packets comprise a request to halt operation to alleviate the congestion.
